(19) United States
(12) Patent Application Publication
(10) Pub. No.: US 2007/0000129 A1
(43) Pub. Date: Jan. 4, 2007

(54) Cylinder liner, method for the production thereof and a combined

(76) Inventors: Dieter Hahn, PLUDERHAUSEN (DE); Patrick Izquierdo, Sedanstrasse (DE); Helmut Profrock, Leutenbach (DE); Juergen Traber, Fellbach (DE); Reinhard Zygor, Berlin (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/558,249

(22) PCT Filed: Apr. 28, 2004
(86) PCT No.: PCT/EP04/04450

§ 371 Date: Feb. 22, 2006

(30) Foreign Application Priority Data
Mar. 28, 2003 (DE) 103 24 279.1

(51) Int. Cl. B23P 6/00; B23P 11/00

(52) U.S. Cl. 29/888.011; 29/888.061

(57) ABSTRACT

The present invention relates to a cylinder liner made from gray cast iron, an aluminum material or a ceramic material for an engine block for an internal combustion engine. According to the invention, it is provided that the cylinder liner has a thermally sprayed layer of a low-alloy iron alloy or a bonding layer, which consists of a nickel-aluminum alloy made up of 80 to 95% by weight of nickel and 5 to 20% by weight of aluminum, on its worn running surface, and has a layer serving as a tribological running surface on top of the bonding layer. The present invention also relates to a method for producing a cylinder liner of this type and to a composite part made up of an engine block for an internal combustion engine and at least one cylinder liner of this type. The invention allows the inexpensive repair of worn cylinder liners without the need to adapt new pistons.

### CROSS REFERENCE TO RELATED APPLICATIONS

This application claims the priority of German patent document 103 24 279.1, filed May 28, 2003 (PCT International Application No. PCT/EP2004/004450, filed Apr. 28, 2004), the disclosure of which is expressly incorporated by reference herein.

### FIELD OF THE INVENTION

The present invention relates to a cylinder liner for an internal combustion engine and related methods and composite parts.

### BACKGROUND OF THE INVENTION

Liners of the generic type are known. They are located in the cylinder bores in the crankcase of internal combustion engines and are used to provide tribological running surfaces which are suitable for the pistons accommodated in the cylinder bores. Light-metal die-cast crankcases with cast-in liners made from aluminum materials (Silitec 5, Alusil, Locasil, etc.) are usually used. The liners may also be made from gray cast iron or ceramic materials, and can also be pressed in rather than cast in, especially in gray cast iron housings.

Liners of this type and their tribological running surfaces are subject to wear over the course of time as a result of their use. Once a defined wear rate is present, the liner has to be repaired. For this purpose, the worn liner is turned to a defined dimension (for example 0.3 mm), honed and then uncovered. This creates a new tribological running surface. Next, new pistons with rings are adapted to the new diameter of the liners. These pistons are more expensive than series-produced pistons by a factor of about 3 to 4, since they are manufactured individually.

U.S. Pat. No. 5,873,163 A discloses a process in which the corroded surface region of liners is repaired by grinding it down and then fitting a ring. The ring is fixed to the ground surface by an anaerobic bonding substance. This avoids having to replace the entire liner. This process does not offer a solution to the present problem, since it does not allow complete replacement of the running surface of the liner.

U.S. Pat. No. 4,918,805 A describes a welding process for repairing cylinder heads for diesel engines, in which cracks in the cylinder head are welded using various metal alloys. However, welding processes are unsuitable for repairing tribological running surfaces, since they cannot be used to achieve the desired friction or running properties.

DE 28 41 446 C2 discloses a process for producing a composite body from a metal part and a light metal cast layer, in which an interlayer of aluminum or an aluminum alloy is applied to the metal part by high-temperature spraying, and then a layer of an aluminum alloy is cast.

DE 38 16 348 A1 discloses a process for producing metal-composite cast workpieces, in which the surface of a workpiece to be coated is roughened and provided with a coupling layer, for example in the form of a low-melting metal alloy, such as a nickel-base alloy. The workpiece is then heated to the flow temperature of the coupling layer and surrounded by casting.

### SUMMARY OF THE INVENTION

One object of the present invention is to provide a liner and a method which allows for simple and inexpensive repair of tribological running surfaces of liners.

This and other objects are achieved with a cylinder liner made from gray cast iron, an aluminum material or a ceramic material, characterized in that a layer of a low-alloy Fe-base alloy is applied to the worn running surface of the cylinder liner by means of arc wire spraying.

A method for repairing a cylinder liner made from gray cast iron, an aluminum material or a ceramic material, is also provided and includes the steps of:
applying a bonding layer of a nickel-aluminum alloy made up of 80 to 95% by weight of nickel and 5 to 20% by weight of aluminum to the worn running surface of the cylinder liner, and
applying a layer which serves as a tribological running surface.

In one embodiment of the invention, the cylinder liner has at least one thermally sprayed layer on its worn running surface. The surprising advantage of the present invention is that cylinder liners made from different materials, namely from gray cast iron, an aluminum material or a ceramic material, can be repaired or renewed in the same way. The direct application of at least one thermally sprayed layer, with at least the top, uncovered layer having tribological properties, makes it possible to adapt the internal diameter of the cylinder liner to the dimensions of the series-produced pistons (with rings). As a result, the present invention allows effective and inexpensive repair of worn running surfaces without the need to adapt new pistons (and new rings). This allows for a cost reduction by a factor of 3 to 4 (in the optimum scenario).

Other objects, advantages and novel features of the present invention will become apparent from the following detailed description of the invention when considered in conjunction with the accompanying claims.

### DETAILED DESCRIPTION

One of the two particularly preferred variants of the present invention provides for a layer of a low-alloy Fe-base alloy, preferably a low-alloy Fe—C alloy, which is thermally sprayed onto a worn running surface. Surprisingly, this alloy is suitable for cylinder running pistons and running surfaces made from any material and has suitable bonding properties on the worn running surface.

An alloy of this type is preferably applied by arc wire spraying, in which case one or two wires made from the respective alloy are used as spraying material. This layer has tribological properties and can be honed and if appropriate uncovered in the usual way, so as to form a new running surface. During subsequent treatment, the internal diameter of the cylinder liner provided with this new running surface can be matched to the dimensions of the series-produced pistons (with rings). Therefore, the thickness of the newly applied layer also depends on the degree of adaptation of the internal diameter which is required.

The second particularly preferred variant of the present invention provides for the cylinder liner to have a bonding layer, which consists of a nickel-aluminum alloy made of 80 to 95% by weight of nickel and 5 to 20% by weight of aluminum, on the worn running surface. A new layer is then applied to the bonding layer and serves as a tribological running surface. Surprising to the person skilled in the art the composition of the nickel-aluminum alloy ensures firm bonding of uniform quality between the material of the cylinder liner or the worn running surface and the newly applied layer. Furthermore, there are no gaps or splits in the region of the bonding.

The bonding layer in particular is from 50 to 200 μm, preferably 100 μm, thick, and is preferably applied to the inner surface of the cylinder liner by plasma spraying. It is preferable for a powder of the same material as the bonding layer, i.e. a nickel-aluminum alloy made up of 80 to 95% by weight of nickel and 5 to 20% by weight of aluminum, to be used for the plasma spraying.

The new layer, which serves as a tribological running surface, preferably consists of the same material as the cylinder liner or the old, worn running surface. Therefore, there is also no need for the pistons to be adapted to new running surface materials, and the previous running properties of the engine can be restored.

For both preferred variants, the cylinder liner may, in a manner known per se, be made from gray cast iron or an aluminum material, preferably an Si-hypereutectic Al—Si alloy, as are known, for example, under the trade names Silitec 5, Alusil etc. The cylinder liner may also be made from ceramic materials, for example oxide ceramics, ceramic-metal composite materials, silicon carbide ceramics or fiber-reinforced SiC/SiC or C/SiC ceramics.

In any event, it is advantageous for the worn running surface to be pretreated, in particular roughened, for example by means of high-pressure water blasting or corundum blasting, prior to the application of the first thermally sprayed layer, in order to improve the bonding between the worn running surface and the first thermally sprayed layer.

Exemplary embodiments of the present invention are explained in more detail in the text which follows.

The method according to the invention can be used to treat liners made from a very wide range of materials, as has already been explained above. By way of example, DE 197 17 825 A1 describes a crankcase made from an aluminum-base alloy (such as AlSi8Cu, AlSi9Cu, AlSi10Cu as near-eutectic alloys) with a layer of aluminum nitride, which is securely anchored in the base material and is homogeneous in terms of its structure, as running surface.

Furthermore, DE 44 38 550 A1 describes a cylinder liner made from a hypereutectic aluminum-silicon alloy which includes fine primary silicon crystals and intermetallic phases in the form of hard particles. A material of this type is surface-machined by carrying out precision-boring in a first step. Then, the surface is smoothed by honing. In series production, this takes place in at least two working steps, known as rough-honing and finish-honing. In a final step, the silicon particles which are contained in the alloy and form the actual running surface are uncovered by aluminum being etched out with the aid of an aqueous solution of an acid.

German patent applications DE 197 33 204 A1 and DE 197 33 205 A1 disclose a thermally sprayed coating of a hypereutectic aluminum-silicon alloy or an aluminum-silicon composite material which is distinguished by a heterogeneous layer microstructure made up of aluminum solid solution, a coarse to very fine network of eutectic silicon, silicon precipitations or particles, intermetallic phases and extremely finely distributed oxides. This coating has characteristic primary aluminum solid solution dendrites, the dendrite arms of which are encased by eutectic silicon. The microsections through coatings of this type reveal a characteristic sponge-like appearance. There is only a small proportion of primary silicon precipitations and silicon particles, and these have only a small diameter. During the surface-machining of these layers, the dendrite arms which are present at the surface are partially ground, so that during the subsequent uncovering step, the aluminum is etched away and aluminum-free silicon skeletons which form the actual running surface remain.

A worn liner made from the latter material, comprising 23 to 40% by weight, preferably 25% by weight, of silicon, at most 0.6% by weight of zirconium, 0.25% by weight of iron and in each case 0.01% by weight of manganese, copper, nickel and zinc, remainder aluminum, is cleaned, for example by sandblasting, and, if appropriate, roughened, for example by high-pressure water blasting or corundum blasting, for the pretreatment of the worn tribological running surface. The surface which has been pretreated in this way is provided with a bonding layer of a bonding layer material made up of 80-95% by weight of nickel and 20-5% by weight of aluminum. The bonding layer material is in the form of an alloy in powder form and is applied by plasma spraying processes which are known per se, as described for example in DE 195 08 687 C2. The thickness of the bonding layer is such that the worn running surface, including all roughnesses and depressions, is completely covered by the bonding layer. At the thinnest points, the thickness of the bonding layer should be approximately 0.05 to 0.1 mm.

A new tribological layer of the same material as that which forms the liner is applied to the bonding layer. In this case too, this application is effected by plasma spraying processes, as described in DE 197 33 204 A1 and DE 197 33 205 A1. This new layer once again serves as a running surface for the repaired liner. The thickness of the tribological layer is such that during the standard subsequent processing (honing, uncovering), the original diameter of the liner is restored, so that series-produced pistons (with rings) can be fitted into it.

Before it solidifies, the bonding layer bonds to the worn surface of the liner, with the two layers penetrating into one another to a depth of approximately 0.01 to 0.1 mm. The bonding layer and the new tribological layer are similarly joined.

A worn cylinder liner with a height of 140 mm and a diameter of 93 mm made from the material Silitec 5 was treated in a similar way. First, the worn tribological running surface was cleaned by sand-blasting and then covered with a 100 μm thick bonding layer made up of 95% by weight of nickel and 5% by weight of aluminum by a plasma spraying process. Then, the bonding layer was covered with a new layer of Silitec 5, which serves as a tribological running surface, also by a plasma spraying process. This layer was then honed and uncovered in the usual way, with the internal diameter of the cylinder liner being matched to the dimensions of the desired series pistons (with rings).

As an alternative to plasma spraying processes, it is also possible to use other thermal spraying processes, such as flame spraying and arc wire spraying. The choice of thermal spraying process depends on the material of the cylinder liner and of the bonding layer and on the type of microstructure which is desired.

These criteria can be suitably matched to one another by a person skilled in the art in a manner which is known per se.

A further cylinder liner made from the above-described material (Silitec 5) was pretreated in the same way (cleaned and roughened by means of sandblasting), and then a low-alloy Fe—C alloy was applied by means of arc wire spraying. During the subsequent treatment (honing, uncovering), the internal diameter of the cylinder liner was adapted to the dimensions of the pistons (with rings) to be used.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-14. (canceled)

15. A cylinder liner made from gray cast iron, an aluminum material or a ceramic material for an engine block for an internal combustion engine with a worn running surface, comprising either:
at least one thermally sprayed layer of a low-alloy FeC alloy, which is applied by arc wire spraying and has tribological properties, on the worn running surface, or
a thermally sprayed bonding layer of a nickel-aluminum alloy of 80 to 95% by weight of nickel and 5 to 20% by weight of aluminum applied to the worn running surface, and a thermally sprayed layer serving as a tribological running surface applied on top of this bonding layer.

16. The cylinder liner as claimed in claim 15, wherein the bonding layer is from 50 to 150 μm thick.

17. The cylinder liner as claimed in claim 15, wherein the bonding layer is 100 μm thick.

18. The cylinder liner as claimed in claim 15 having a bonding layer, wherein the bonding layer is applied by plasma spraying.

19. The cylinder liner as claimed in claim 15, wherein the cylinder liner is made from an Si-hypereutectic Al—Si alloy.

20. A composite part comprising an engine block for an internal combustion engine and at least one cylinder liner made from gray cast iron, an aluminum material or a ceramic material, wherein the cylinder liner comprises either
at least one thermally sprayed layer of a low-alloy FeC alloy, which is applied by arc wire spraying and has tribological properties, on a worn running surface of a cylinder, or
a thermally sprayed bonding layer of a nickel-aluminum alloy of 80 to 95% by weight of nickel and 5 to 20% by weight of aluminum, on a worn running surface of a cylinder, and then a thermally sprayed layer which serves as a tribological running surface on top of the bonding layer.

21. The composite part as claimed in claim 20 having a bonding layer, wherein the bonding layer is applied to an inner surface of the at least one cylinder liner by plasma spraying.

22. The composite part as claimed in claim 20, wherein the layer which serves as a tribological running surface consists of the same material as the cylinder liner or the worn running surface.

23. The composite part as claimed in claim 20, wherein the cylinder liner is made from an Si-hypereutectic Al—Si alloy.

24. A method for repairing a cylinder liner made from gray cast iron, an aluminum material or a ceramic material, comprising the steps of:
applying a layer of a low-alloy FeC alloy to a worn running surface of a cylinder liner by arc wire spraying, or
pretreating a worn running surface of the cylinder liner,
applying a bonding layer of a nickel-aluminum alloy made up of 80 to 95% by weight of nickel and 5 to 20% by weight of aluminum to the worn running surface of the cylinder liner, and
applying a layer which serves as a tribological running surface.

25. The method as claimed in claim 24, wherein the step of pretreating comprises cleaning the worn running surface.

26. The method as claimed in claim 24, wherein the bonding layer is applied in a thickness of from 50 to 150 μm.

27. The method as claimed in claim 26, wherein the bonding layer is applied in a thickness of 100 μm.

28. The method as claimed in claim 24, wherein the layer which serves as a tribological running surface is made from the same material as the cylinder liner or the worn running surface.

29. The method as claimed claim 24, wherein the cylinder liner is made from an Si-hypereutectic Al—Si alloy.

30. The method as claimed claim 24, wherein at least the bonding layer is applied by plasma spraying.

31. The method as claimed in claim 30, wherein a powder of a nickel-aluminum alloy made up of 80 to 95% by weight of nickel and 5 to 20% by weight of aluminum is used in the plasma spraying.
